(19) United States
(12) Patent Application Publication
(10) Pub. No.: US 2008/0106539 A1
(43) Pub. Date: May 8, 2008

(54) Power supply circuit for liquid crystal display device

(75) Inventors: Kun Le, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.; INNOLUX DISPLAY CORP.

(21) Appl. No.: 11/982,867

(22) Filed: Nov. 5, 2007

(30) Foreign Application Priority Data
Nov. 3, 2006 (TW) 95140738

(51) Int. Cl. G09G 5/00

(52) U.S. Cl. 345/211

(57) ABSTRACT

An exemplary power supply circuit (3) for a liquid crystal display device includes an interface board (30) having a first DC/DC converter (32), and a power board (31) having an AC/DC converter (37), a second DC/DC converter (35), and an inverter (33). The AC/DC converter is configured for supplying a DC voltage to the first and second DC/DC converters. The first DC/DC converter is configured for converting the DC voltage to operating voltages desired by other circuits of the interface board, and the second DC/DC converter is configured for converting the DC voltage to an operating voltage desired by a main chip of the inverter.

### FIELD OF THE INVENTION

The present invention relates to power supply circuits used in liquid crystal display (LCD) devices; and particularly to a power supply circuit having two direct current/direct current (DC/DC) converters, one of which specially supplies an operating voltage to a main chip of an inverter of an LCD device.

### BACKGROUND

LCD devices are commonly used as displays for compact electronic apparatuses. This is because they not only provide good quality images with little power consumption, but also they are very thin. A typical LCD device includes a power supply circuit, which supplies operating voltages for various kinds of working units in the LCD device.

Referring to FIG. 3, a conventional power supply circuit 1 for an LCD device (not labeled) includes a power board 11 and an interface board 10. The power board 11 is used to supply power voltages to various kinds of circuit elements of the LCD device. The interface board 10 is used to supply signals to a driving circuit 18 of the LCD device. The signals include various kinds of control signals. The power board 11 includes an alternating current/direct current (AC/DC) converter 17 and an inverter 13. The interface board 10 includes a DC/DC converter 12, a plurality of ports (not shown), and other circuits (not shown) such as a scaling circuit, a main control unit, and the like. The ports are used to transmit control signals or other signals to the driving circuit 18.

The AC/DC converter 17 converts an AC voltage supplied by an external source to a DC voltage of 12V, and supplies the 12V DC voltage to the inverter 13 and the DC/DC converter 12. The DC/DC converter 12 converts the 12V DC voltage to a DC voltage of 5V, and supplies the 5V DC voltage as an operating voltage to other circuits of the interface board 10 and a main chip (not shown) of the inverter 13. The inverter 13 converts the 12V DC voltage to an AC voltage, and supplies the AC voltage to a light source 19 of the LCD device for driving the light source 19 to emit light beams.

The power board 11 and the interface board 10 are different kinds of circuit boards. Most of circuits of the interface board 10 are digital circuits, which have very strict specifications such as those relating to stability of operating voltage, noise interference, magnitude of signal ripples, and the like. In order to satisfy the strict requirements of the digital circuits of the interface board 10, the DC/DC converter 12 is disposed on the interface board 10. Thereby, transmission paths of the operating voltage of 5V between the DC/DC converter 12 and the digital circuits of the interface board 10 are shortened. However, the operating voltage of 5V required by the main chip of the inverter 13 is supplied by the same DC/DC converter 12. Due to the DC/DC converter 12 being disposed on the interface board 10, a transmission path of the 5V operating voltage along a connecting wire between the DC/DC converter 12 and the main chip of the inverter 13 is long. The voltage of the long transmission path is liable to induce noise in neighboring circuits. In addition, a resistance of the long connecting wire may be substantial, and is liable to cause a large voltage drop from the original operating voltage of 5V. In such case, the power requirements of the main chip of the inverter 13 may not be met.

To overcome the above-described deficiencies, a multiplex AC/DC converter is used. The multiplex AC/DC converter can convert an AC voltage to several different DC voltages.

Referring to FIG. 4, this shows another conventional power supply circuit 2 for an LCD device (not labeled). The power supply circuit 2 is similar to the power supply circuit 1. However, the power supply circuit 2 includes an AC/DC converter 27, which is a multiplex AC/DC converter. The AC/DC converter 27 supplies a DC voltage of 12V to a DC/DC converter 22 of an interface board 20 and an inverter 23 of a power board 21, and a DC voltage of 5V to a main chip (not shown) of the inverter 23.

The DC voltage of 5V required by the main chip of the inverter 23 is supplied directly by the AC/DC converter 27. Thereby, a transmission path of the 5V DC voltage between the AC/DC converter 27 and the main chip of the inverter 23 is shortened, and noise induced in neighboring circuits is correspondingly reduced. However, the multiplex AC/DC converter 27 has a complicated circuit construction consisting of many internal electronic components. Thus the multiplex AC/DC converter 27 is expensive, and the cost of the power supply circuit 2 is correspondingly high.

What is needed, therefore, is a power supply circuit that can overcome the above-described deficiencies.

### SUMMARY

A power supply circuit used for a liquid crystal display device is provided. In one aspect, the power supply circuit includes an interface board having a first DC/DC converter, and a power board having an AC/DC converter, a second DC/DC converter, and an inverter. The AC/DC converter is configured for supplying a DC voltage to the first and second DC/DC converters. The first DC/DC converter is configured for supplying operating voltages to other circuits of the interface board, and the second DC/DC converter is configured for supplying an operating voltage to a main chip of the inverter.

In another aspect, the power supply circuit includes an interface board having a first DC/DC converter, and a power board having a second DC/DC converter and an inverter. The first DC/DC converter is configured for receiving a DC voltage from the power board and converting the DC voltage to operating voltages needed by other circuits of the interface board, and the second DC/DC converter is configured for converting the DC voltage to an operating voltage needed by a main chip of the inverter.

Other novel features and advantages will become more apparent from the following detailed description when taken in conjunction with the accompanying drawings.

### BRIEF DESCRIPTION OF THE DRAWINGS

The emphasis in the drawings is placed upon clearly illustrating the principles of various embodiments of the present invention. Like reference numerals designate corresponding parts throughout various drawings.

FIG. 1 is a block diagram of a power supply circuit according to a first embodiment of the present invention.

FIG. 2 is a block diagram of a power supply circuit according to a second embodiment of the present invention.

FIG. 3 is a block diagram of a conventional power supply circuit for an LCD device.

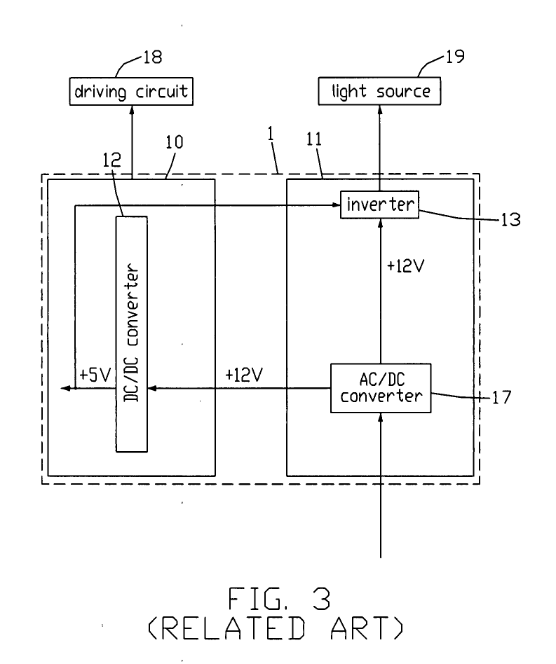

FIG. 4 is a block diagram of another conventional power supply circuit for an LCD device.

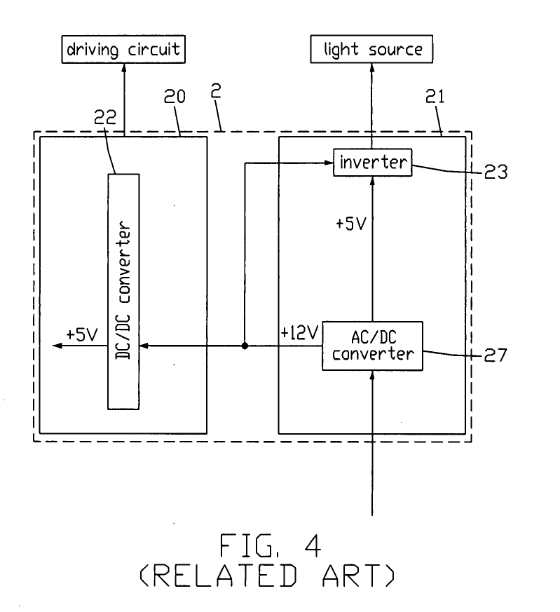

### DETAILED DESCRIPTION OF PREFERRED EMBODIMENTS

Reference will now be made to the drawings to describe preferred embodiments of the present invention in detail.

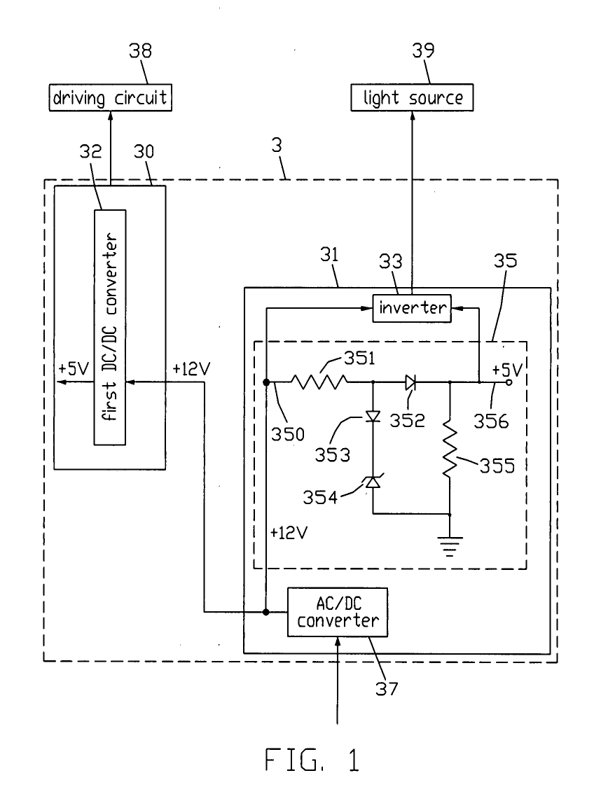

Referring to FIG. 1, a power supply circuit 3 for an LCD device according to a first embodiment of the present invention is shown. The power supply circuit 3 includes an interface board 30 and a power board 31. The interface board 30 includes a first DC/DC converter 32, a plurality of ports (not shown), and other circuits (not shown). The ports are used to transmit control signals or other signals to a driving circuit 38 of the LCD device (not labeled). The power board 31 includes an AC/DC converter 37, a second DC/DC converter 35, and an inverter 33.

The second DC/DC converter 35 includes an input terminal 350, a first resistor 351, a first diode 352, a second diode 353, a Zener diode 354, a second resistor 355, and an output terminal 356. The input terminal 350 is connected to the output terminal 356 via the first resistor 351 and the first diode 352, and an anode (not labeled) of the first diode 352 is connected to the first resistor 351, and a cathode (not labeled) of the first diode 352 is connected to the output terminal 356. The input terminal 350 is grounded via the first resistor 351, the second diode 353, and the Zener diode 354. An anode (not labeled) of the second diode 353 is connected to the first resistor 351, a cathode (not labeled) of the second diode 353 is connected to a cathode (not labeled) of the Zener diode 354, and an anode (not labeled) of the Zener diode 354 is grounded. The output terminal 356 is grounded via the second resistor 355.

The first and second diodes 352, 353 are used to provide a cutoff function in order to protect the Zener diode 354 when an unwanted negative voltage is applied to the second DC/DC converter 35 via the input terminal 350. The first resistor 351 is used as a current-limiting resistor. A resistance R₁ of the first resistor 351 is governed by the following formula: R₁<(Vᵢ−Vₒ−V_{d1})/I_{R2}, where Vᵢ is an input voltage of the input terminal 350 received from the AC/DC converter 37, Vₒ is an output voltage of the output terminal 356 supplied to a main chip (not shown) of the inverter 33 as an operating voltage of the main chip, V_{d1} is a forward working voltage of the first diode 352, and I_{R2} is a load current passing through the second resistor 355. A forward working voltage V_{d2} of the second diode 353 is equal to the forward working voltage V_{d1} of the first diode 352, and a Zener voltage V_{Z} is determined according to the output voltage Vₒ. For example, if the operating voltage of the main chip of the inverter 13 is 5V, the Zener diode 354 can be chosen a Zener diode having a Zener voltage V_{Z} of 5V, and then the output voltage Vₒ is 5V. When the input voltage Vᵢ is 12V, both forward working voltages V_{d1}, V_{d2} are 0.6V, and the resistance R₁ is in the range: R₁<(Vᵢ−Vₒ−V_{d1})/I_{R2}; i.e. R₁<(12V−5V−0.6V)/I_{R2}; which reduces to R₁<6.4V/I_{R2}.

When an external source (not shown) supplies an AC voltage to the AC/DC converter 37, the AC/DC converter 37 converts the AC voltage to a first DC voltage, and supplies the first DC voltage to the inverter 33, the first DC/DC converter 32, and the second DC/DC converter 35. The first DC/DC converter 32 converts the first DC voltage to a second DC voltage, and supplies the second DC voltage as an operating voltage to other circuits of the interface board 30. The second DC/DC converter 35 receives the first DC/DC voltage via the input terminal 350, converts the first DC voltage to a third DC voltage, and supplies the third DC voltage as an operating voltage to the main chip of the inverter 33 via the output terminal 356. The inverter 33 converts the first DC/DC voltage to an AC voltage by using the main chip, and supplies the AC voltage to a light source 39 of the LCD device for driving the light source 39 to emit light beams.

In summary, the second DC/DC converter 35 is disposed in the power board 31, and supplies the operating voltage directly to the main chip of the inverter 33. Therefore a transmission path between the second DC/DC converter 35 and the main chip of the inverter 33 is shortened, and noise induced in neighboring circuits is correspondingly reduced. In addition, the second DC/DC converter 35 is comprised of relatively few standard electronic components, such as resistors, diodes, and the like, and is formed as a shunt regulating circuit to convert the first DC voltage to the third DC voltage. That is, the structure of the second DC/DC converter 35 is simple and inexpensive, so that the cost of the power supply circuit 3 is correspondingly inexpensive. Thus, the power supply circuit 3 not only provides good, efficient performance, but also has a low cost.

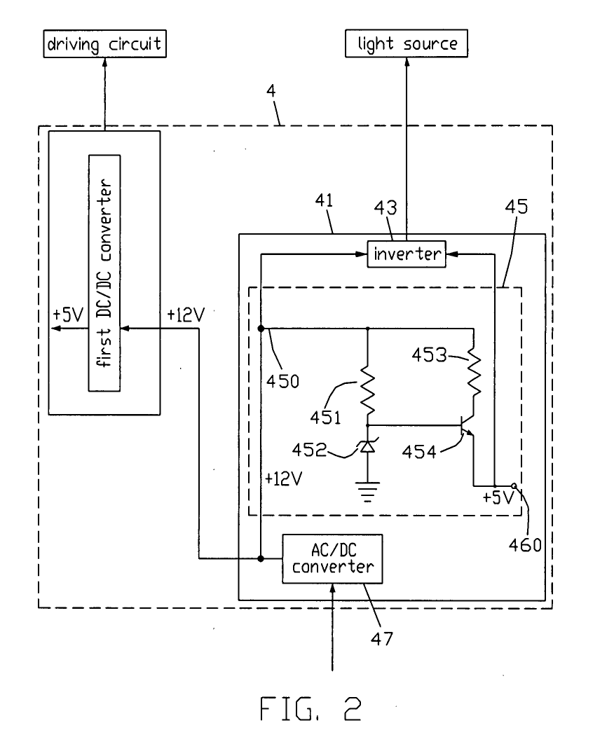

Referring to FIG. 2, a power supply circuit 4 for an LCD device according to a second embodiment of the present invention is shown. The power supply circuit 4 is similar to the power supply circuit 3. However, a second DC/DC converter 45 of a power board 41 includes an input terminal 450, a first resistor 451, a Zener diode 452, a second resistor 453, a transistor 454, and an output terminal 460. The input terminal 450 is used to receive a DC voltage supplied by an AC/DC converter 47 of the power board 41. The output terminal 460 is used to supply an operating voltage to a main chip (not shown) of an inverter 43. The input terminal 450 is connected to the output terminal 460 via the second resistor 453 and a collector (not labeled) and an emitter (not labeled) of the transistor 454. The input terminal 450 is grounded via the first resistor 451 and the Zener diode 452. A cathode (not labeled) of the Zener diode 452 is connected to the first resistor 451, and an anode (not labeled) of the Zener diode 452 is grounded. A base (not labeled) of the transistor 454 is connected to the cathode of the Zener diode 452.

The transistor 454 may be a 2N3904 type transistor. When the second DC/DC converter 45 is working, the transistor 454 works in an amplifying mode; and an emitter junction of the transistor 454 is forward biased, and a collector junction of the transistor 454 is reverse biased. A voltage V_{CE} between the collector and the emitter may be larger than 1V, and a voltage V_{BE} between the base and the emitter may be 0.7V. The types of the Zener diode 452 and the transistor 454 are determined according to an output voltage Vₒ of the output terminal 460. A value of the output voltage Vₒ is governed by the following formula: Vₒ=V_{Z}−V_{BE}, where the voltage V_{Z} is a working voltage of the Zener diode 452. For example, if the operating voltage of the main chip of the inverter 33 is 5V, the Zener diode 452 may be chosen to be a 1N4734 type Zener diode. Accordingly, a working voltage V_{Z} of the Zener diode 452 is 5.7V, and a test current I_{ZT} of the Zener diode 452 is 45 mA. Thus, by means of voltage stabilizing provided by the Zener diode 452, a voltage V_{B} of the base is 5.7V, and a voltage V_{E} of the emitter is equal to V_{B}−V_{BE}=5.7V−0.7V=5V. That is, the output voltage Vₒ of the output terminal 460 is 5V.

When the second DC/DC converter 45 works for a long time, it is necessary to avoid thermal deterioration of the Zener diode 452 caused by the existence of an inverse current. Thus, a resistance R₁ of the first resistor 451 is governed by the following formula: R₁>(Vᵢ−V_{Z})/0.7I_{ZT}, where the voltage Vᵢ is an input voltage of the input terminal 450 from the AC/DC converter 47. To ensure that the transistor 454 works with an amplification characteristic, a resistance R₂ of the second resistor 453 is governed by the following formula: R₂<(Vᵢ−Vₒ−V_{CE})/I₂, where the current I₂ is an emitter load current or a working current of the main chip of the inverter 43. For example, if the input voltage Vᵢ is 12V and the output voltage Vₒ is 5V, the resistance R₁ of the first resistor 451 is in the range: R₁>(Vᵢ−V_{Z})/0.7I_{ZT}; i.e. R₁>(12V−5.7V)/(0.7×45 mA); which reduces to R₁>200Ω (ohms). Furthermore, if the working current I₂ of the main chip of the inverter 43 is 2.5 mA, the resistance R₂ of the second resistor 453 is in the range: R₂<(Vᵢ−Vₒ−V_{CE})/I₂; i.e. R₂<(12V−5V−1V)/2.5 mA; which reduces to R₂<2400Ω.

In summary, the second DC/DC converter 45 is disposed in the power board 41, and supplies the operating voltage directly to the main chip of the inverter 43. Therefore a transmission path between the second DC/DC converter 45 and the main chip of the inverter 43 is shortened, and noise induced in neighboring circuits is correspondingly reduced. In addition, the second DC/DC converter 45 is comprised of relatively few standard electronic components, such as resistors, diodes, and the like. That is, the structure of the second DC/DC converter 45 is simple and inexpensive, so that the cost of the power supply circuit 4 is correspondingly inexpensive. Thus, the power supply circuit 4 not only provides good, efficient performance, but also has a low cost.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A power supply circuit for a liquid crystal display device, comprising:
an interface board having a first DC/DC converter; and
a power board having an AC/DC converter, a second DC/DC converter, and an inverter;
wherein the AC/DC converter is configured for supplying a DC voltage to the first and second DC/DC converters, the first DC/DC converter is configured for supplying operating voltages to other circuits of the interface board, and the second DC/DC converter is configured for supplying an operating voltage to a main chip of the inverter.

2. The power supply circuit as claimed in claim 1, wherein the AC/DC converter is configured for receiving an AC voltage supplied by an external source, and converting the AC voltage to the DC voltage.

3. The power supply circuit as claimed in claim 2, wherein the first DC/DC converter is configured for converting the DC voltage to the operating voltages needed by the other circuits of the interface board.

4. The power supply circuit as claimed in claim 2, wherein the second DC/DC converter is configured for converting the DC voltage to the operating voltage needed by the main chip of the inverter.

5. The power supply circuit as claimed in claim 2, wherein the DC voltage is supplied to the inverter, and the inverter is configured for converting the DC voltage to an AC voltage used to driving a light source of the liquid crystal display device.

6. The power supply circuit as claimed in claim 4, wherein the second DC/DC converter is configured as a shunt regulating circuit.

7. The power supply circuit as claimed in claim 6, wherein the second DC/DC converter comprises an input terminal, a first resistor, a first diode, a second diode, a Zener diode, a second resistor, and an output terminal, the input terminal is configured for receiving the DC voltage supplied by the AC/DC converter, the output terminal is configured for supplying the operating voltage to the main chip of the inverter; the input terminal is coupled to the output terminal via the first resistor and the first diode, an anode of the first diode is coupled to the first resistor, a cathode of the first diode is coupled to the output terminal, an anode of the second diode is coupled to the anode of the first diode, a cathode of the second diode is coupled to a cathode of the Zener diode, an anode of the Zener diode is grounded, and the output terminal is grounded via the second resistor.

8. The power supply circuit as claimed in claim 7, wherein a forward working voltage of the second diode is equal to a forward working voltage of the first diode.

9. The power supply circuit as claimed in claim 8, wherein a Zener voltage of the Zener diode is equal to the operating voltage of the main chip of the inverter.

10. The power supply circuit as claimed in claim 7, wherein a resistance R₁ of the first resistor is governed by the following formula: R₁<(Vᵢ−Vₒ−V_{d1})/I_{R2}, where Vᵢ is an input voltage of the input terminal, Vₒ is an output voltage of the output terminal, V_{d1} is a forward working voltage of the first diode, and I_{R2} is a load current passing through the second resistor.

11. The power supply circuit as claimed in claim 4, wherein the second DC/DC converter comprises an input terminal, a first resistor, a Zener diode, a second resistor, a transistor, and an output terminal, the input terminal is configured for receiving the DC voltage supplied by the AC/DC converter, the output terminal is configured for supplying the operating voltage to the main chip of the inverter, the input terminal is coupled to the output terminal via the second resistor and a collector and an emitter of the transistor; the input terminal is grounded via the first resistor and the Zener diode, a cathode of the Zener diode is coupled to the first resistor, an anode of the Zener diode is grounded, and a base of the transistor is connected to the cathode of the Zener diode.

12. The power supply circuit as claimed in claim 11, wherein an emitter junction of the transistor is forward biased, and a collector junction of the transistor is reverse biased.

13. The power supply circuit as claimed in claim 11, wherein a relationship of the Zener diode, the transistor, and the output voltage Vₒ of the output terminal is governed by the following formula: Vₒ=V_{Z}−V_{BE}, where the voltage V_{Z} is a Zener voltage of the Zener diode, and the voltage V_{BE} is a voltage between the base and the emitter of the transistor.

14. The power supply circuit as claimed in claim 13, wherein a resistance R₁ of the first resistor is governed by the following formula: R₁>(Vᵢ−V_{Z})/0.7I_{ZT}, where the voltage Vᵢ is an input voltage of the input terminal from the AC/DC converter, and the current I_{ZT} is a test current of the Zener diode.

15. The power supply circuit as claimed in claim 14, wherein a resistance R₂ of the second resistor is governed by the following formula: R₂<(Vᵢ−Vₒ−V_{CE})/I₂, where the voltage V_{CE} is a voltage between the collector and the emitter of the transistor, and the current I₂ is an emitter load current.

16. A power supply circuit for a liquid crystal display device, comprising:
an interface board having a first DC/DC converter; and
a power board having a second DC/DC converter and an inverter;
wherein the first DC/DC converter is configured for receiving a DC voltage of 12V from the power board and converting the 12V DC voltage to operating voltages needed by other circuits of the interface board, and the second DC/DC converter is configured for converting the 12V DC voltage to an operating voltage needed by a main chip of the inverter.

17. The power supply circuit as claimed in claim 16, wherein the 12V DC voltage is supplied to the inverter, and the inverter is configured for converting the 12V DC voltage to an AC voltage used for driving a light source of the liquid crystal display device.

18. The power supply circuit as claimed in claim 16, wherein the second DC/DC converter is configured as a shunt regulating circuit.

19. The power supply circuit as claimed in claim 18, wherein the second DC/DC converter comprises an input terminal, a first resistor, a first diode, a second diode, a Zener diode, a second resistor, and an output terminal, the input terminal is configured for receiving the 12V DC voltage supplied by the power board, the output terminal is configured for supplying the operating voltage to the main chip of the inverter, with the operating voltage being 5V, the input terminal is coupled to the output terminal via the first resistor and the first diode, an anode of the first diode is coupled to the first resistor, a cathode of the first diode is coupled to the output terminal, an anode of the second diode is coupled to the anode of the first diode, a cathode of the second diode is coupled to a cathode of the Zener diode, an anode of the Zener diode is grounded, and the output terminal is grounded via the second resistor.

20. The power supply circuit as claimed in claim 16, wherein the second DC/DC converter comprises an input terminal, a first resistor, a Zener diode, a second resistor, a transistor, and an output terminal, the input terminal is configured for receiving the 12V DC voltage supplied by the power board, the output terminal is configured for supplying the operating voltage to the main chip of the inverter, with the operating voltage being 5V, the input terminal is coupled to the output terminal via the second resistor and a collector and an emitter of the transistor; the input terminal is grounded via the first resistor and the Zener diode, a cathode of the Zener diode is coupled to the first resistor, an anode of the Zener diode is grounded, and a base of the transistor is connected to the cathode of the Zener diode.
